(19) United States
(12) Patent Application Publication
(10) Pub. No.: US 2025/0348772 A1
(43) Pub. Date: Nov. 13, 2025

(54) AUGMENTING A LIMITED DATASET BY LEVERAGING BOTH QUANTUM AND CLASSICAL SYSTEMS

(71) Applicant: International Business Machines Corporation, Armonk, NY (US)

(72) Inventors: Mitsuharu Takeori, Kashiwa (JP); Noriaki Shimada, Kawasaki (JP)

(21) Appl. No.: 18/658,449

(22) Filed: May 8, 2024

(51) Int. Cl. G06N 10/60; G06N 10/20

(52) U.S. Cl. CPC G06N 10/60; G06N 10/20

(57) ABSTRACT

A method, system, and computer program product for augmenting a limited dataset with data to optimize an indicator value. A quantum model is trained on a quantum computer with a known dataset to identify the relationship between the feature vectors consisting of binary data and the associated objective variables. A quantum state of the quantum model is measured by the quantum computer by employing a quantum circuit to obtain a collection of observed bitstrings. Furthermore, index values are calculated by a classical computer based on the collection of observed bitstrings. An optimal indicator value is calculated by the classical computer based on the index values and the observed bitstrings. The data point that optimizes the indicator value is then identified by the quantum computer. The dataset is then updated by the classical computer with the identified data point and the best indicator value within the updated dataset is adjusted accordingly.

### TECHNICAL FIELD

The present disclosure relates generally to data augmentation, and more particularly to augmenting a limited dataset with data that optimizes an indicator value by leveraging both quantum and classical systems.

### BACKGROUND

A dataset with binary features may consist of data points D={X, Y}, where such data points correspond to feature vectors consisting of binary data, denoted as X, along with associated objective variables denoted as Y. An example of such data points include material fingerprints.

Material fingerprinting is a topologically-based methodology for classifying the material structure (e.g., crystal structure) of material data (e.g., APT data) with near-perfect accuracy especially in the binary case. Material data, such as atom probe tomography (APT), provides three-dimensional compositional mapping with sub-nanometer resolution. The sensitivity of APT is in the range of parts per million for all elements, including light elements, such as hydrogen, carbon or lithium, enabling unique insights into the composition of performance-enhancing or lifetime-limiting microstructural features and making APT ideally suited to complement electron-based or X-ray-based microscopies and spectroscopies.

Such material fingerprints may represent the components of the material and their corresponding physical properties. The mathematical relationship between these features and objectives, f: X→Y may not be known. It may only be obtained through resource-intensive processes, such as experiments or simulations, for each data point. The primary purpose is to find a data point {x*, y*} that optimizes (minimizes or maximizes) a certain indicator value (a specific metric, such as the physical property or test data accuracy) Ind∈ [symbol] in a data-driven way, where

$${x}^{*} = {arg min}_{x ∈ {𝔹}^{N}} [ Ind ] , {y}^{*} = f ( {x}^{*} ) .$$

In certain situations, a certain number of data points D_{K}={X_{K}, Y_{K}} with feature-objective pairs may be known. However, such known data points exist within a larger set of potential points (e.g., 2^{N} in total, where N is the dimension of the binary feature vectors), denoted as D_{U}={X_{U}, Y_{U}}. As a result, attempts have been made to select new data points from D_{U} in order to obtain or predict the optimal value of Ind (indicator value).

For example, quantum annealing (optimization process for finding the global minimum of a given objective function over a given set of candidate solutions using quantum fluctuations) and factorization machines may be utilized to predict the new data points in order to obtain or predict the optimal value of the indicator value. Such an approach relies on a second order model, known as the factorization machine. The factorization machine is a supervised algorithm that can be used for classification, regression, and ranking tasks. Unfortunately, the model may not be accurate for data that cannot be captured by a second-order representation.

Furthermore, such an approach is computation-intensive as it requires solving optimization problems, such as QUBO (quadratic unconstrained binary optimization), to obtain the best solution each time.

Consequently, there is not currently a means for efficiently selecting new data points from a limited dataset that optimizes (minimizes or maximizes) an indicator value in order to obtain or predict the optimal indicator value.

### SUMMARY

In one embodiment of the present disclosure, a method for augmenting a limited dataset with data to optimize an indicator value comprises training, on a quantum computer, a quantum model with the dataset. The method further comprises measuring, by the quantum computer, a quantum state of the quantum model by employing a quantum circuit to obtain a collection of observed bitstrings. The method additionally comprises calculating, by a classical computer, index values based on the collection of observed bitstrings. Furthermore, the method comprises calculating, by the classical computer, the indicator value based on the index values and the collection of observed bitstrings. Additionally, the method comprises identifying, by the quantum computer, a data point that optimizes the indicator value. In addition, the method comprises updating, by the classical computer, the dataset with the identified data point.

Furthermore, in one embodiment of the present disclosure, the method additionally comprises updating, by the classical computer, parameters of the quantum circuit that optimizes the indicator value.

Additionally, in one embodiment of the present disclosure, the updating of the parameters of the quantum circuit is performed using stochastic methods, where the stochastic methods comprise one of the following from the group consisting of Bayesian optimization and covariance matrix adaptation evolution.

Furthermore, in one embodiment of the present disclosure, the method additionally comprises identifying, by the quantum computer, the data point that optimizes the indicator value by employing the quantum circuit after updating the parameters of the quantum circuit.

Additionally, in one embodiment of the present disclosure, the method further comprises measuring, by the quantum computer, a value of an objective variable as a function of binary data that optimizes the indicator value by employing the quantum circuit after updating the parameters of the quantum circuit, where the objective variable and the binary data collectively form the identified data point.

Furthermore, in one embodiment of the present disclosure, the method additionally comprises adjusting a best indicator value within the dataset with the identified data point.

Additionally, in one embodiment of the present disclosure, the quantum model is constructed based on machine learning models.

Other forms of the embodiments of the method described above are in a system and in a computer program product.

Accordingly, embodiments of the present disclosure effectively select new data points from a limited dataset that optimizes (minimizes or maximizes) an indicator value by combining quantum and classical elements in order to obtain or predict the optimal indicator value.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for augmenting a limited dataset with data that optimizes an indicator value by leveraging both quantum and classical systems in order to obtain or predict the optimal indicator value in accordance with an embodiment of the present disclosure;

FIG. 3 illustrates an embodiment of the present disclosure of the hardware configuration of the classical computer which is representative of a hardware environment for practicing the present disclosure; and

FIG. 4 is a flowchart of a method for augmenting a limited dataset with data that optimizes an indicator value by leveraging both quantum and classical systems in order to obtain or predict the optimal indicator value in accordance with an embodiment of the present disclosure.

### DETAILED DESCRIPTION

In one embodiment of the present disclosure, a method for augmenting a limited dataset with data to optimize an indicator value comprises training, on a quantum computer, a quantum model with the dataset. The method further comprises measuring, by the quantum computer, a quantum state of the quantum model by employing a quantum circuit to obtain a collection of observed bitstrings. The method additionally comprises calculating, by a classical computer, index values based on the collection of observed bitstrings. Furthermore, the method comprises calculating, by the classical computer, the indicator value based on the index values and the collection of observed bitstrings. Additionally, the method comprises identifying, by the quantum computer, a data point that optimizes the indicator value. In addition, the method comprises updating, by the classical computer, the dataset with the identified data point.

In this manner, new data points are effectively selected from a limited dataset that optimizes (minimizes or maximizes) an indicator value by combining quantum and classical elements in order to obtain or predict the optimal indicator value.

Furthermore, in one embodiment of the present disclosure, the method additionally comprises updating, by the classical computer, parameters of the quantum circuit that optimizes the indicator value.

In this manner, the parameters of the quantum circuit are updated in order to optimize the indicator value.

Additionally, in one embodiment of the present disclosure, the updating of the parameters of the quantum circuit is performed using stochastic methods, where the stochastic methods comprise one of the following from the group consisting of Bayesian optimization and covariance matrix adaptation evolution.

In this manner, the parameters of the quantum circuits can be updated using a classical stochastic optimizer.

Furthermore, in one embodiment of the present disclosure, the method additionally comprises identifying, by the quantum computer, the data point that optimizes the indicator value by employing the quantum circuit after updating the parameters of the quantum circuit.

In this manner, the dataset is updated with a new data point that optimizes the indicator value in order to predict or obtain the best or optimal indicator value.

Additionally, in one embodiment of the present disclosure, the method further comprises measuring, by the quantum computer, a value of an objective variable as a function of binary data that optimizes the indicator value by employing the quantum circuit after updating the parameters of the quantum circuit, where the objective variable and the binary data collectively form the identified data point.

In this manner, the dataset is updated with a new data point that optimizes the indicator value.

Furthermore, in one embodiment of the present disclosure, the method additionally comprises adjusting a best indicator value within the dataset with the identified data point.

In this manner, the best or optimal indicator is predicted or obtained upon updating the dataset with a new data point that optimizes the indicator value.

Additionally, in one embodiment of the present disclosure, the quantum model is constructed based on machine learning models.

In this manner, a quantum data model can be constructed based on machine learning models, such as kernel methods and neural networks, depending on the nature of the problem.

Other forms of the embodiments of the method described above are in a system and in a computer program product.

As stated above, a dataset with binary features may consist of data points D={X, Y}, where such data points correspond to feature vectors consisting of binary data, denoted as X, along with associated objective variables denoted as Y. An example of such data points include material fingerprints.

Material fingerprinting is a topologically-based methodology for classifying the material structure (e.g., crystal structure) of material data (e.g., APT data) with near-perfect accuracy especially in the binary case. Material data, such as atom probe tomography (APT), provides three-dimensional compositional mapping with sub-nanometer resolution. The sensitivity of APT is in the range of parts per million for all elements, including light elements, such as hydrogen, carbon or lithium, enabling unique insights into the composition of performance-enhancing or lifetime-limiting microstructural features and making APT ideally suited to complement electron-based or X-ray-based microscopies and spectroscopies.

Such material fingerprints may represent the components of the material and their corresponding physical properties. The mathematical relationship between these features and objectives, f: X→Y may not be known. It may only be obtained through resource-intensive processes, such as experiments or simulations, for each data point. The primary purpose is to find a data point {x*, y*} that optimizes (minimizes or maximizes) a certain indicator value (a specific metric, such as the physical property or test data accuracy) Ind∈ [symbol] in a data-driven way, where

$${x}^{*} = {arg min}_{x ∈ {𝔹}^{N}} [ Ind ] , {y}^{*} = f ( {x}^{*} ) .$$

In certain situations, a certain number of data points D_{K}={X_{K}, Y_{K}} with feature-objective pairs may be known. However, such known data points exist within a larger set of potential points (e.g., 2^{N} in total, where N is the dimension of the binary feature vectors), denoted as D_{U}={X_{U}, Y_{U}}. As a result, attempts have been made to select new data points from D_{U} in order to obtain or predict the optimal value of Ind (indicator value).

For example, quantum annealing (optimization process for finding the global minimum of a given objective function over a given set of candidate solutions using quantum fluctuations) and factorization machines may be utilized to predict the new data points in order to obtain or predict the optimal value of the indicator value. Such an approach relies on a second order model, known as the factorization machine. The factorization machine is a supervised algorithm that can be used for classification, regression, and ranking tasks. Unfortunately, the model may not be accurate for data that cannot be captured by a second-order representation.

Furthermore, such an approach is computation-intensive as it requires solving optimization problems, such as QUBO (quadratic unconstrained binary optimization), to obtain the best solution each time.

Consequently, there is not currently a means for efficiently selecting new data points from a limited dataset that optimizes (minimizes or maximizes) an indicator value in order to obtain or predict the optimal indicator value.

The embodiments of the present disclosure provide the means for augmenting a limited dataset with data points to optimize the indicator value (a specific metric, such as the physical property or test data accuracy) in order to obtain or predict the optimal indicator value. In one embodiment, a quantum state of a quantum model, that was previously trained with a limited dataset, is measured by employing a quantum circuit to obtain a collection of observed bitstrings (sequence of binary digits). Index values may then be calculated (index values refer to the objective variables of the dataset) based on the observed bitstrings. An indicator value may then be calculated based on the index values and the collection of observed bitstrings. For example, an optimal indicator value is computed across the obtained dataset consisting of the obtained collection of observed bitstrings and the index values. Parameters of the quantum circuit are then updated to optimize (e.g., minimize) the indicator value. The data point that optimizes the indicator value by employing the quantum circuit after updating the parameters of the quantum circuits is then identified. The dataset is then updated with the identified data point and the best indicator value is adjusted within the updated dataset. The above process iterates until a stopping criteria has been met. Once the stopping criteria has been met, the best indicator value is returned. These and other features will be discussed in further detail below.

In some embodiments of the present disclosure, the present disclosure comprises a method, system, and computer program product for augmenting a limited dataset with data to optimize an indicator value. In one embodiment of the present disclosure, a quantum model (e.g., QUBO model) (F) is trained on a quantum computer with a known dataset, D_{K}={X_{K}, Y_{K}}, to identify the relationship between the feature vectors consisting of binary data, denoted as X, and the associated objective variables, denoted as Y. A quantum state of the quantum model is measured by the quantum computer by employing a quantum circuit to obtain a collection X_{S} of observed bitstrings (sequence of binary digits). In one embodiment, a quantum circuit |φ(θ) [symbol] with N qubits is employed. In one embodiment, such a quantum circuit is parameterized by certain circuit parameters θ. In one embodiment, bitstring sampling is performed by measuring this quantum circuit as shown by the following formula:

$$\vert φ ( θ ) 〉 \approx {\sum }_{x ∈ {X}_{S}} a ( x ) \vert x 〉 .$$

Furthermore, index values Y_{S} are calculated by a classical computer based on the collection X_{S} of observed bitstrings, which are contained in X_{K} (binary data of the known dataset) and X_{U} (binary data of the unknown dataset). Index values Y_{S}, as used herein, refer to the objective variables of the dataset. In one embodiment, index values, Y_{S}, correspond to the index values Y_{K} (index values based on X_{K}) and the index values Y_{U} (index values based on X_{U}). In one embodiment, index values Y_{U} are obtained from X_{U} using quantum model (F). An optimal indicator value, Ind, is calculated by the classical computer based on the index values and the collection of observed bitstrings. For example, in one embodiment, the optimal indicator value, Ind, is computed across the obtained dataset D_{S}={X_{S}, Y_{S}}. In one embodiment, with the obtained data sampling D_{S}, the optimal indicator value (z) is calculated as follows:

$$z = {min}_{x ∈ {X}_{S}} Ind ( x , y ) , y ∈ f ( {X}_{S} ⋂ {X}_{K} ) ⋃ F ( {X}_{S} ⋂ {X}_{U} ) .$$

The data point that optimizes the indicator value is then identified by the quantum computer by employing the quantum circuit after updating the parameters of the quantum circuit. For example, in one embodiment, after updating the quantum circuit parameters θ, the actual value of y*=f(x*) for x*=argmin Ind(x, y) is measured through experiment or simulation, where x*, y* correspond to the new data point and where argmin corresponds to the function that returns the value of x* which optimizes (e.g., minimizes) f(x*) over the set of candidates for x* as opposed to the minimum value itself. The dataset D_{K} (known dataset) is then updated by the classical computer with the identified data point, {x*, y*}, and the best indicator value within the updated dataset D_{K} is adjusted accordingly. For example, the best indicator value is adjusted to correspond to the value of z. In this manner, new data points may be effectively selected from a limited dataset that optimizes (minimizes or maximizes) an indicator value by combining quantum and classical elements in order to obtain or predict the optimal indicator value.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

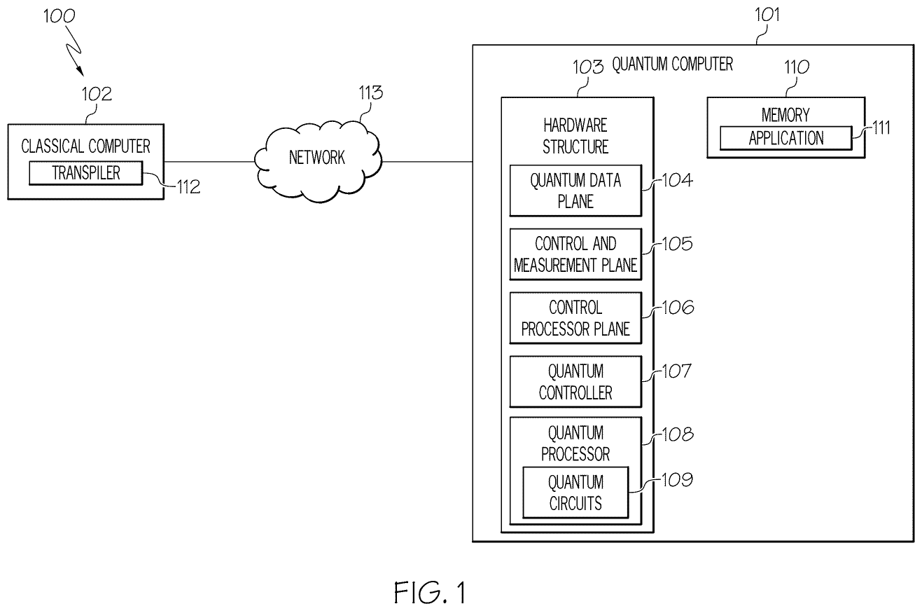

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to augment a limited dataset with data that optimizes an indicator value by leveraging both quantum and classical systems in order to obtain or predict the optimal indicator value as discussed further below.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously.

Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθx/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

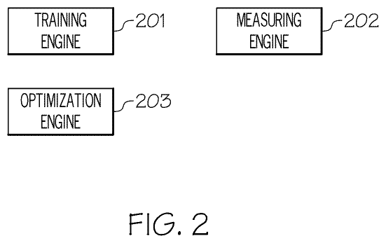

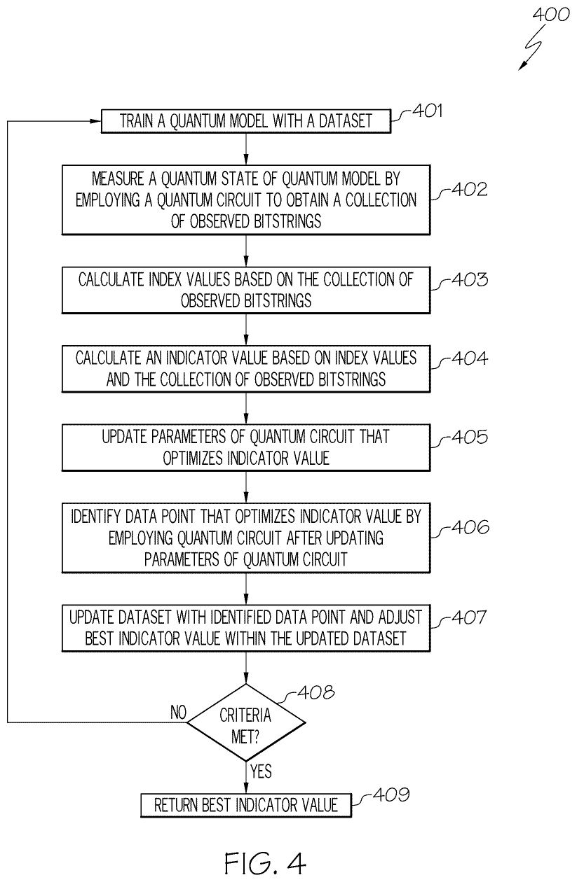

In one embodiment, memory 110 stores an application 111 that may be configured to implement one or more of the methods described herein in accordance with one or more embodiments. For example, application 111 may implement a program for augmenting a limited dataset with data that optimizes an indicator value by leveraging both quantum and classical systems in order to obtain or predict the optimal indicator value as discussed further below in connection with FIGS. 2 and 4. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

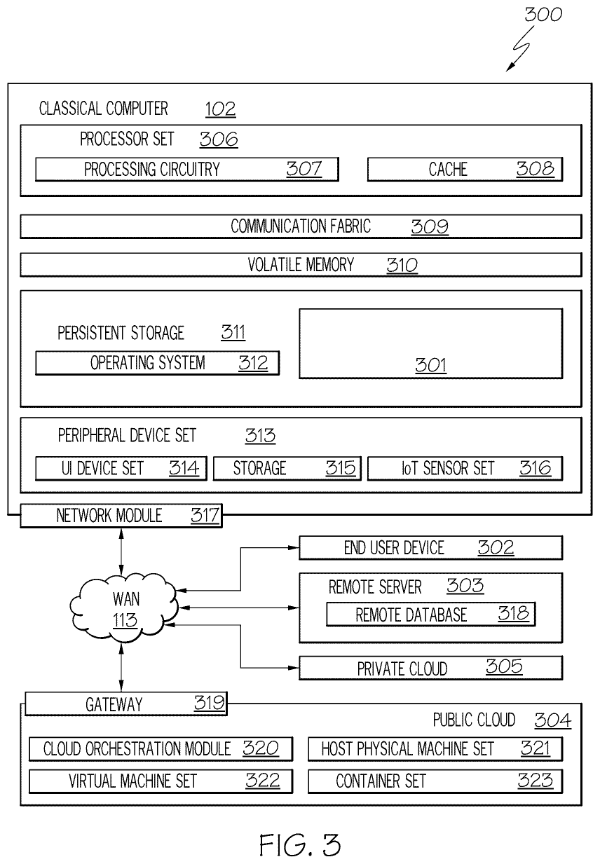

Furthermore, classical computer 102 is configured to augment a limited dataset with data that optimizes an indicator value by leveraging both quantum and classical system in order to obtain or predict the optimal indicator value as discussed further below in connection with FIGS. 2 and 4. A description of the software components of classical computer 102 is provided below in connection with FIG. 2 and a description of the hardware configuration of classical computer 102 is provided further below in connection with FIG. 3.

System 100 is not to be limited in scope to any one particular network architecture. System 100 may include any number of quantum computers 101, classical computers 102, and networks 113.

A discussion regarding the software components used by classical computer 102 for augmenting a limited dataset with data that optimizes an indicator value by leveraging both quantum and classical system in order to obtain or predict the optimal indicator value is provided below in connection with FIG. 2.

FIG. 2 is a diagram of the software components of classical computer 102 (FIG. 1) for augmenting a limited dataset with data that optimizes an indicator value by leveraging both quantum and classical systems in order to obtain or predict the optimal indicator value.

Referring to FIG. 2, in conjunction with FIG. 1, classical computer 102 includes a training engine 201 configured to train a quantum model (e.g., QUBO model) (F) on quantum computer 101 with a known dataset to identify the relationship between the feature vectors consisting of binary data, denoted as X, and the associated objective variables, denoted as Y.

In one embodiment, training engine 201 trains the quantum model (F) on quantum computer 101 with the known dataset D_{K}={X_{K}, Y_{K}} to identify the relationship between the feature vectors consisting of binary data, denoted as X, and the associated objective variables, denoted as Y. Such a dataset represents the dataset with limited data that needs to be augmented with data that optimizes an indicator value (a specific metric, such as the physical property or test data accuracy) in order to obtain or predict the optimal indicator value.

In one embodiment, the quantum model (F) is constructed based on machine learning models, such as kernel methods (use linear classifiers to solve nonlinear problems) or neural networks (machine learning program or model that makes decisions in a manner similar to the human brain by using processes that mimic the way biological neurons work together to identify phenomena, weigh options and arrive at conclusions).

In one embodiment, the quantum model (F) corresponds to a variational quantum classifier (VQC), where the VQC class includes a feature map and ansatz. In one embodiment, the dataset D_{K} used to train the quantum model (F) to identify the relationship between the feature vectors consisting of binary data and the associated objective variables is encoded as qubits. Such mapping is the role of the feature map. An example of a feature map is the ZZFeatureMap from the Qiskit® circuit library. In particular, the feature map encodes classical data to the quantum state space by using a quantum circuit.

In one embodiment, once the data is loaded, a parameterized quantum circuit (also referred to as “ansatz”) is applied. Such a circuit has a set of tunable parameters or weights. The weights are optimized such that they minimize an objective function. The objective function characterizes the distance between the predictions and the known labeled data.

In one embodiment, an optimization algorithm is used in the training process, such as a gradient-free optimizer (e.g., COBYLA in Qiskit®).

Furthermore, classical computer 102 includes a measuring engine 202 configured to measure a quantum state of the quantum model using quantum computer 101 by employing a quantum circuit to obtain a collection X_{S} of observed bitstrings (sequence of binary digits).

In one embodiment, a quantum circuit |φ(θ) [symbol] with N qubits is employed. In one embodiment, such a quantum circuit is parameterized by certain circuit parameters θ. In one embodiment, bitstring sampling is performed by measuring this quantum circuit as shown by the formula below:

$$\vert φ ( θ ) 〉 \approx {\sum }_{x ∈ {X}_{S}} a ( x ) \vert x 〉 .$$

The principles of the present disclosure seek to obtain the most optimal data point from the sampling set X_{S} generated by the quantum state. It is noted that X_{S} may not be entirely contained within X_{K}. In one embodiment, such missing data points may be contained within data points X_{U} (binary data of the unknown dataset). In such an embodiment, the predictions (e.g., the associated objective variables, denoted as Y_{U}) made by the quantum model (F) are relied upon. Such predictions form index values Y_{S} as discussed below.

In one embodiment, measuring engine 202 calculates index values Y_{S} using classical computer 102 based on the collection X_{S} of observed bitstrings, which are contained in X_{K} and X_{U}.

Index values Y_{S}, as used herein, refer to the objective variables of the dataset. In one embodiment, index values, Y_{S}, correspond to the index values Y_{K} (index values based on X_{K}) and the index values Y_{U} (index values based on X_{U}). In one embodiment, index values Y_{U} are obtained from X_{U} using quantum model (F).

In one embodiment, index values Y_{S} correspond to the objective function (e.g., squared error (SE)) to be minimized. For example, an index value may be computed from SE(y*, F(xᵢ))=(y*−F(xᵢ))² where xᵢ is one observed bitstring and F is the trained quantum model.

In one embodiment, such observed bitstrings may be akin to storing bitmap indexes. A bitmap index is a special type of index that uses a series of bitstrings to represent the set of objects that correspond to a given value for a particular property. Each bit in the bitmap represents an object in the class.

In one embodiment, measuring engine 202 calculates an optimal indicator value, Ind, using classical computer 102 based on the index values and the collection of observed bitstrings.

For example, in one embodiment, the optimal indicator value, Ind, is computed across the obtained dataset D_{S}={X_{S}, Y_{S}}.

In one embodiment, with the obtained data sampling D_{S}, the optimal indicator value (z) is calculated as follows:

$$z = {min}_{x ∈ {X}_{S}} Ind ( x , y ) , y ∈ f ( {X}_{S} ⋂ {X}_{K} ) ⋃ F ( {X}_{S} ⋂ {X}_{U} ) .$$

In one embodiment, Y_{S}=F(X_{S}), where F is the trained quantum model and X_{S} is the observed bitstring. When using the Squared Error, Ind(X_{S}, Y_{S})=(y*−Y_{S})²=(y*−F(X_{S})), where y* denotes the target value.

Furthermore, classical computer 102 includes optimization engine 203 configured to update the parameters θ of the quantum circuit that optimizes (e.g., minimizes) the indicator value using classical computer 102. That is, the parameters θ of the quantum circuit are updated according to the value of z.

In one embodiment, such an update process is performed using classical stochastic methods. Examples of such stochastic methods include, but are not limited to, Bayesian optimization and covariance matrix adaptation evolution strategy.

Bayesian optimization, as used herein, refers to a sequential design strategy for global optimization of black-box functions that does not assume any functional forms.

Covariance matrix adaptation evolution strategy, as used herein, is a strategy for numerical optimization. Evolution strategies (ES) are stochastic, derivative-free methods for numerical optimization of non-linear or non-convex continuous optimization problems. Such evolution strategies belong to the class of evolutionary algorithms and evolutionary computation. An evolutionary algorithm is broadly based on the principle of biological evolution, namely, the repeated interplay of variation (via recombination and mutation) and selection: in each generation (iteration) new individuals (candidate solutions) are generated by variation, usually in a stochastic way, of the current parental individuals. Then, some individuals are selected to become the parents in the next generation based on their fitness or objective function value.

Furthermore, in one embodiment, optimization engine 203 identifies the data point that optimizes the indicator value using quantum computer 101 by employing the quantum circuit after updating the parameters of the quantum circuit.

In one embodiment, a value of an objective variable as a function of binary data that optimizes the indicator value is measured by quantum computer 101 by employing the quantum circuit after updating the parameters of the quantum circuit. The objective variable and the binary data collectively form the identified data point. For example, in one embodiment, after updating the quantum circuit parameters θ, optimization engine 203 measures the actual value of y*=f(x*) for x*=argmin Ind(x, y) through experiment or simulation, where x*, y* correspond to the new data point and where argmin corresponds to the function that returns the value of x* which optimizes (e.g., minimizes) f(x*) over the set of candidates for x* as opposed to the minimum value itself.

In one embodiment, optimization engine 203 updates the dataset D_{K} with the identified data point, {x*, y*}, and adjusts the best indicator value within the updated dataset D_{K} accordingly. For example, the best indicator value is adjusted to correspond to the value of z. The “best indicator value,” as used herein, refers to the indicator value with a value that is optimal or most optimized (e.g., minimized, maximized).

Furthermore, in one embodiment, upon updating the dataset, optimization engine 203 determines whether the process discussed above is to be repeated based on predefined stopping criteria, which may be user-specified. If the criteria has been met, then optimization engine 203 outputs the best indicator value that was obtained through the process discussed above. Otherwise, the process discussed above is repeated where the data model (F) is continuously refined as new data is gathered through the iterations. Over time, the quantum state of the quantum model converges toward a probability distribution that contains the true optimal value guided by the classical stochastic updates.

In this manner, the principles of the present disclosure combine quantum and classical elements to actively learn and identify the optimized indicator value.

A further description of these and other functions is provided below in connection with the discussion of the method for augmenting a limited dataset with data that optimizes an indicator value by leveraging both quantum and classical systems in order to obtain or predict the optimal indicator value.

Prior to the discussion of the method for augmenting a limited dataset with data that optimizes an indicator value by leveraging both quantum and classical systems in order to obtain or predict the optimal indicator value, a description of the hardware configuration of classical computer 102 (FIG. 1) is provided below in connection with FIG. 3.

Referring now to FIG. 3, in conjunction with FIG. 1, FIG. 3 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 300 contains an example of an environment for the execution of at least some of the computer code 301 involved in performing the inventive methods, such as augmenting a limited dataset with data that optimizes an indicator value by leveraging both quantum and classical systems in order to obtain or predict the optimal indicator value. In addition to block 301, computing environment 300 includes, for example, classical computer 102, network 113, such as a wide area network (WAN), end user device (EUD) 302, remote server 303, public cloud 304, and private cloud 305. In this embodiment, classical computer 102 includes processor set 306 (including processing circuitry 307 and cache 308), communication fabric 309, volatile memory 310, persistent storage 311 (including operating system 312 and block 301, as identified above), peripheral device set 313 (including user interface (UI) device set 314, storage 315, and Internet of Things (IoT) sensor set 316), and network module 317. Remote server 303 includes remote database 318. Public cloud 304 includes gateway 319, cloud orchestration module 320, host physical machine set 321, virtual machine set 322, and container set 323.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 318. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically classical computer 102, to keep the presentation as simple as possible. Classical computer 102 may be located in a cloud, even though it is not shown in a cloud in FIG. 3. On the other hand, classical computer 102 is not required to be in a cloud except to any extent as may be affirmatively indicated.

Processor set 306 includes one, or more, computer processors of any type now known or to be developed in the future. Processing circuitry 307 may be distributed over multiple packages, for example, multiple, coordinated integrated circuit chips. Processing circuitry 307 may implement multiple processor threads and/or multiple processor cores. Cache 308 is memory that is located in the processor chip package(s) and is typically used for data or code that should be available for rapid access by the threads or cores running on processor set 306. Cache memories are typically organized into multiple levels depending upon relative proximity to the processing circuitry. Alternatively, some, or all, of the cache for the processor set may be located “off chip.” In some computing environments, processor set 306 may be designed for working with qubits and performing quantum computing.

Computer readable program instructions are typically loaded onto classical computer 102 to cause a series of operational steps to be performed by processor set 306 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 308 and the other storage media discussed below. The program instructions, and associated data, are accessed by processor set 306 to control and direct performance of the inventive methods. In computing environment 300, at least some of the instructions for performing the inventive methods may be stored in block 301 in persistent storage 311.

Communication fabric 309 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 310 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 310 is located in a single package and is internal to classical computer 102, but, alternatively or additionally, the volatile memory may be distributed over multiple packages and/or located externally with respect to classical computer 102.

Persistent Storage 311 is any form of non-volatile storage for computers that is now known or to be developed in the future. The non-volatility of this storage means that the stored data is maintained regardless of whether power is being supplied to classical computer 102 and/or directly to persistent storage 311. Persistent storage 311 may be a read only memory (ROM), but typically at least a portion of the persistent storage allows writing of data, deletion of data and re-writing of data. Some familiar forms of persistent storage include magnetic disks and solid state storage devices. Operating system 312 may take several forms, such as various known proprietary operating systems or open source Portable Operating System Interface type operating systems that employ a kernel. The code included in block 301 typically includes at least some of the computer code involved in performing the inventive methods.

Peripheral device set 313 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 314 may include components such as a display screen, speaker, microphone, wearable devices (such as goggles and smart watches), keyboard, mouse, printer, touchpad, game controllers, and haptic devices. Storage 315 is external storage, such as an external hard drive, or insertable storage, such as an SD card. Storage 315 may be persistent and/or volatile. In some embodiments, storage 315 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 316 is made up of sensors that can be used in Internet of Things applications. For example, one sensor may be a thermometer and another sensor may be a motion detector.

Network module 317 is the collection of computer software, hardware, and firmware that allows classical computer 102 to communicate with other computers through WAN 113. Network module 317 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 317 are performed on the same physical hardware device. In other embodiments (for example, embodiments that utilize software-defined networking (SDN)), the control functions and the forwarding functions of network module 317 are performed on physically separate devices, such that the control functions manage several different network hardware devices. Computer readable program instructions for performing the inventive methods can typically be downloaded to classical computer 102 from an external computer or external storage device through a network adapter card or network interface included in network module 317.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 302 is any computer system that is used and controlled by an end user (for example, a customer of an enterprise that operates classical computer 102), and may take any of the forms discussed above in connection with classical computer 102. EUD 302 typically receives helpful and useful data from the operations of classical computer 102. For example, in a hypothetical case where classical computer 102 is designed to provide a recommendation to an end user, this recommendation would typically be communicated from network module 317 of classical computer 102 through WAN 113 to EUD 302. In this way, EUD 302 can display, or otherwise present, the recommendation to an end user. In some embodiments, EUD 302 may be a client device, such as thin client, heavy client, mainframe computer, desktop computer and so on.

Remote server 303 is any computer system that serves at least some data and/or functionality to classical computer 102. Remote server 303 may be controlled and used by the same entity that operates classical computer 102. Remote server 303 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 318 of remote server 303.

Public cloud 304 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 304 is performed by the computer hardware and/or software of cloud orchestration module 320. The computing resources provided by public cloud 304 are typically implemented by virtual computing environments that run on various computers making up the computers of host physical machine set 321, which is the universe of physical computers in and/or available to public cloud 304. The virtual computing environments (VCEs) typically take the form of virtual machines from virtual machine set 322 and/or containers from container set 323. It is understood that these VCEs may be stored as images and may be transferred among and between the various physical machine hosts, either as images or after instantiation of the VCE. Cloud orchestration module 320 manages the transfer and storage of images, deploys new instantiations of VCEs and manages active instantiations of VCE deployments. Gateway 319 is the collection of computer software, hardware, and firmware that allows public cloud 304 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 305 is similar to public cloud 304, except that the computing resources are only available for use by a single enterprise. While private cloud 305 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 304 and private cloud 305 are both part of a larger hybrid cloud.

Block 301 further includes the software components discussed above in connection with FIG. 2 to augment a limited dataset with data that optimizes an indicator value by leveraging both quantum and classical systems in order to obtain or predict the optimal indicator value. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for augmenting a limited dataset with data that optimizes an indicator value by leveraging both quantum and classical systems in order to obtain or predict the optimal indicator value, may be embodied in an application specific integrated circuit.

As stated above, a dataset with binary features may consist of data points D={X, Y}, where such data points correspond to feature vectors consisting of binary data, denoted as X, along with associated objective variables denoted as Y. An example of such data points include material fingerprints. Material fingerprinting is a topologically-based methodology for classifying the material structure (e.g., crystal structure) of material data (e.g., APT data) with near-perfect accuracy especially in the binary case. Material data, such as atom probe tomography (APT), provides three-dimensional compositional mapping with sub-nanometer resolution. The sensitivity of APT is in the range of parts per million for all elements, including light elements, such as hydrogen, carbon or lithium, enabling unique insights into the composition of performance-enhancing or lifetime-limiting microstructural features and making APT ideally suited to complement electron-based or X-ray-based microscopies and spectroscopies. Such material fingerprints may represent the components of the material and their corresponding physical properties. The mathematical relationship between these features and objectives, f: X→Y may not be known. It may only be obtained through resource-intensive processes, such as experiments or simulations, for each data point. The primary purpose is to find a data point {x*, y*} that optimizes (minimizes or maximizes) a certain indicator value (a specific metric, such as the physical property or test data accuracy) Ind∈ [symbol] in a data-driven way, where

$${x}^{*} = {arg min}_{x ∈ {𝔹}^{N}} [ Ind ] , {y}^{*} = f ( {x}^{*} ) .$$

In certain situations, a certain number of data points D_{K}={X_{K}, Y_{K}} with feature-objective pairs may be known. However, such known data points exist within a larger set of potential points (e.g., 2^{N} in total, where N is the dimension of the binary feature vectors), denoted as D_{U}={X_{U}, Y_{U}}. As a result, attempts have been made to select new data points from D_{U} in order to obtain or predict the optimal value of Ind (indicator value). For example, quantum annealing (optimization process for finding the global minimum of a given objective function over a given set of candidate solutions using quantum fluctuations) and factorization machines may be utilized to predict the new data points in order to obtain or predict the optimal value of the indicator value. Such an approach relies on a second order model, known as the factorization machine. The factorization machine is a supervised algorithm that can be used for classification, regression, and ranking tasks. Unfortunately, the model may not be accurate for data that cannot be captured by a second-order representation. Furthermore, such an approach is computation-intensive as it requires solving optimization problems, such as QUBO (quadratic unconstrained binary optimization), to obtain the best solution each time. Consequently, there is not currently a means for efficiently selecting new data points from a limited dataset that optimizes (minimizes or maximizes) an indicator value in order to obtain or predict the optimal indicator value.

The embodiments of the present disclosure provide the means for augmenting a limited dataset with data points to optimize the indicator value (a specific metric, such as the physical property or test data accuracy) in order to obtain or predict the optimal indicator value as discussed below in connection with FIG. 4.

FIG. 4 is a flowchart of a method 400 for augmenting a limited dataset with data that optimizes an indicator value by leveraging both quantum and classical systems in order to obtain or predict the optimal indicator value in accordance with an embodiment of the present disclosure.

Referring to FIG. 4, in conjunction with FIGS. 1-3, in step 401, training engine 201 of classical computer 102 trains a quantum model (e.g., QUBO model) (F) on quantum computer 101 with a known dataset to identify the relationship between the feature vectors consisting of binary data, denoted as X, and the associated objective variables, denoted as Y.

As discussed above, in one embodiment, training engine 201 trains the quantum model (F) on quantum computer 101 with the known dataset D_{K}={X_{K}, Y_{K}} to identify the relationship between the feature vectors consisting of binary data, denoted as X, and the associated objective variables, denoted as Y. Such a dataset represents the dataset with limited data that needs to be augmented with data that optimizes an indicator value (a specific metric, such as the physical property or test data accuracy) in order to obtain or predict the optimal indicator value.

In one embodiment, the quantum model (F) is constructed based on machine learning models, such as kernel methods (use linear classifiers to solve nonlinear problems) or neural networks (machine learning program or model that makes decisions in a manner similar to the human brain by using processes that mimic the way biological neurons work together to identify phenomena, weigh options and arrive at conclusions).

In one embodiment, the quantum model (F) corresponds to a variational quantum classifier (VQC), where the VQC class includes a feature map and ansatz. In one embodiment, the dataset D_{K} used to train the quantum model (F) to identify the relationship between the feature vectors consisting of binary data and the associated objective variables is encoded as qubits. Such mapping is the role of the feature map. An example of a feature map is the ZZFeatureMap from the Qiskit® circuit library. In particular, the feature map encodes classical data to the quantum state space by using a quantum circuit.

In one embodiment, once the data is loaded, a parameterized quantum circuit (also referred to as “ansatz”) is applied. Such a circuit has a set of tunable parameters or weights. The weights are optimized such that they minimize an objective function. The objective function characterizes the distance between the predictions and the known labeled data.

In one embodiment, an optimization algorithm is used in the training process, such as a gradient-free optimizer (e.g., COBYLA in Qiskit®).

In step 402, measuring engine 202 of classical computer 102 measures a quantum state of the quantum model using quantum computer 101 by employing a quantum circuit to obtain a collection X_{S} of observed bitstrings (sequence of binary digits).

As stated above, in one embodiment, a quantum circuit |φ(θ) [symbol] with N qubits is employed. In one embodiment, such a quantum circuit is parameterized by certain circuit parameters θ. In one embodiment, bitstring sampling is performed by measuring this quantum circuit as shown by the formula below:

$$\vert φ ( θ ) 〉 \approx {\sum }_{x ∈ {X}_{S}} a ( x ) \vert x 〉 .$$

The principles of the present disclosure seek to obtain the most optimal data point from the sampling set X_{S} generated by the quantum state. It is noted that X_{S} may not be entirely contained within X_{K}. In one embodiment, such missing data points may be contained within data points X_{U}. In such an embodiment, the predictions (e.g., the associated objective variables, denoted as Y_{U}) made by the quantum model (F) are relied upon. Such predictions form index values Y_{S} as discussed below.

In step 403, measuring engine 202 of classical computer 102 calculates index values Y_{S} using classical computer 102 based on the collection X_{S} of observed bitstrings, which are contained in X_{K} and X_{U}.

As discussed above, index values Y_{S}, as used herein, refer to the objective variables of the dataset. In one embodiment, index values, Y_{S}, correspond to the index values Y_{K} (index values based on X_{K}) and the index values Y_{U} (index values based on X_{U}). In one embodiment, index values Y_{U} are obtained from X_{U} using quantum model (F).

In one embodiment, index values Y_{S} correspond to the objective function (e.g., squared error (SE)) to be minimized. For example, an index value may be computed from SE(y*, F(xᵢ))=(y*−F(xᵢ))² where xᵢ is one observed bitstring and F is the trained quantum model.

In one embodiment, such observed bitstrings may be akin to storing bitmap indexes. A bitmap index is a special type of index that uses a series of bitstrings to represent the set of objects that correspond to a given value for a particular property. Each bit in the bitmap represents an object in the class.

In step 404, measuring engine 202 of classical computer 102 calculates an optimal indicator value, Ind, using classical computer 102 based on the index values and the collection of observed bitstrings.

For example, in one embodiment, the optimal indicator value, Ind, is computed across the obtained dataset D_{S}={X_{S}, Y_{S}}.

As stated above, in one embodiment, with the obtained data sampling D_{S}, the optimal indicator value (z) is calculated as follows:

$$z = {min}_{x ∈ {X}_{S}} Ind ( x , y ) , y ∈ f ( {X}_{S} ⋂ {X}_{K} ) ⋃ F ( {X}_{S} ⋂ {X}_{U} ) .$$

In one embodiment, Y_{S}=F(X_{S}), where F is the trained quantum model and X_{S} is the observed bitstring. When using the Squared Error, Ind(X_{S}, Y_{S})=(y*−Y_{S})²=(y*−F(X_{S})), where y* denotes the target value.

In step 405, optimization engine 203 of classical computer 102 updates the parameters θ of the quantum circuit using classical computer 102 that optimizes (e.g., minimizes) the indicator value. That is, the parameters θ of the quantum circuit are updated according to the value of z.

As discussed above, in one embodiment, such an update process is performed using classical stochastic methods. Examples of such stochastic methods include, but are not limited to, Bayesian optimization and covariance matrix adaptation evolution strategy.

Bayesian optimization, as used herein, refers to a sequential design strategy for global optimization of black-box functions that does not assume any functional forms.

Covariance matrix adaptation evolution strategy, as used herein, is a strategy for numerical optimization. Evolution strategies (ES) are stochastic, derivative-free methods for numerical optimization of non-linear or non-convex continuous optimization problems. Such evolution strategies belong to the class of evolutionary algorithms and evolutionary computation. An evolutionary algorithm is broadly based on the principle of biological evolution, namely, the repeated interplay of variation (via recombination and mutation) and selection: in each generation (iteration) new individuals (candidate solutions) are generated by variation, usually in a stochastic way, of the current parental individuals. Then, some individuals are selected to become the parents in the next generation based on their fitness or objective function value.

In step 406, optimization engine 203 of classical computer 102 identifies the data point that optimizes the indicator value using quantum computer 101 by employing the quantum circuit after updating the parameters of the quantum circuit.

In one embodiment, a value of an objective variable as a function of binary data that optimizes the indicator value is measured by quantum computer 101 by employing the quantum circuit after updating the parameters of the quantum circuit. The objective variable and the binary data collectively form the identified data point. For example, in one embodiment, after updating the quantum circuit parameters θ, optimization engine 203 measures the actual value of y*=f(x*) for x*=argmin Ind(x, y) through experiment or simulation, where x*, y* correspond to the new data point and where argmin corresponds to the function that returns the value of x* which optimizes (e.g., minimizes) f(x*) over the set of candidates for x* as opposed to the minimum value itself.

In step 407, optimization engine 203 of classical computer 102 updates the dataset D_{K} with the identified data point, {x*, y*}, and adjusts the best indicator value within the updated dataset D_{K} accordingly. For example, the best indicator value is adjusted to correspond to the value of z. The “best indicator value,” as used herein, refers to the indicator value with a value that is optimal or most optimized (e.g., minimized, maximized).

In step 408, upon updating the dataset, optimization engine 203 of classical computer 102 determines whether the process discussed above is to be repeated based on predefined stopping criteria, which may be user-specified.

If the criteria has not been meet, then training engine 201 of classical computer 102 continues to train (i.e., refine) the quantum model (e.g., QUBO model) (F) on quantum computer 101 in step 401 as new data is gathered through the iterations. Over time, the quantum state of the quantum model converges toward a probability distribution that contains the true optimal value guided by the classical stochastic updates.

If, however, the criteria has been met, then, in step 409, optimization engine 203 of classical computer 102 outputs or returns the best indicator value that was obtained through the process discussed above.

As a result of the foregoing, new data points may be effectively selected from a limited dataset that optimizes (minimizes or maximizes) an indicator value by combining quantum and classical elements to actively learn and identify the optimized indicator value.

Furthermore, as a result of the foregoing, an optimal dataset is extracted more quickly and accurately than prior methods, such as using quantum annealers.

Furthermore, the principles of the present disclosure may be applied to scenarios where the data structure is known (i.e., the form of function f is known). It is noted that there is no need to update measured data D_{K} in such cases.

Additionally, the principles of the present disclosure may be applied to non-quadratic data structures. Current approaches, as previously discussed, rely upon using the factorization machine. As a result, the accuracy may suffer if the data structure does not fit well with a quadratic model. In contrast, the approach of the present disclosure allows users to design the data model thereby eliminating this limitation.

Furthermore, the principles of the present disclosure improve the technology or technical field involving data augmentation.

As discussed above, a dataset with binary features may consist of data points D={X, Y}, where such data points correspond to feature vectors consisting of binary data, denoted as X, along with associated objective variables denoted as Y. An example of such data points include material fingerprints. Material fingerprinting is a topologically-based methodology for classifying the material structure (e.g., crystal structure) of material data (e.g., APT data) with near-perfect accuracy especially in the binary case. Material data, such as atom probe tomography (APT), provides three-dimensional compositional mapping with sub-nanometer resolution. The sensitivity of APT is in the range of parts per million for all elements, including light elements, such as hydrogen, carbon or lithium, enabling unique insights into the composition of performance-enhancing or lifetime-limiting microstructural features and making APT ideally suited to complement electron-based or X-ray-based microscopies and spectroscopies. Such material fingerprints may represent the components of the material and their corresponding physical properties. The mathematical relationship between these features and objectives, f. X-Y may not be known. It may only be obtained through resource-intensive processes, such as experiments or simulations, for each data point. The primary purpose is to find a data point {x*, y*} that optimizes (minimizes or maximizes) a certain indicator value (a specific metric, such as the physical property or test data accuracy) Ind∈ [symbol] in a data-driven way, where

$${x}^{*} = {arg min}_{x ∈ {𝔹}^{N}} [ Ind ] , {y}^{*} = f ( {x}^{*} ) .$$

In certain situations, a certain number of data points D_{K}={X_{K}, Y_{K}} with feature-objective pairs may be known. However, such known data points exist within a larger set of potential points (e.g., 2^{N} in total, where N is the dimension of the binary feature vectors), denoted as D_{U}={X_{U}, Y_{U}}. As a result, attempts have been made to select new data points from D_{U} in order to obtain or predict the optimal value of Ind (indicator value). For example, quantum annealing (optimization process for finding the global minimum of a given objective function over a given set of candidate solutions using quantum fluctuations) and factorization machines may be utilized to predict the new data points in order to obtain or predict the optimal value of the indicator value. Such an approach relies on a second order model, known as the factorization machine. The factorization machine is a supervised algorithm that can be used for classification, regression, and ranking tasks. Unfortunately, the model may not be accurate for data that cannot be captured by a second-order representation. Furthermore, such an approach is computation-intensive as it requires solving optimization problems, such as QUBO (quadratic unconstrained binary optimization), to obtain the best solution each time. Consequently, there is not currently a means for efficiently selecting new data points from a limited dataset that optimizes (minimizes or maximizes) an indicator value in order to obtain or predict the optimal indicator value.

Embodiments of the present disclosure improve such technology by training a quantum model (e.g., QUBO model) (F) on a quantum computer with a known dataset, D_{K}={X_{K}, Y_{K}}, to identify the relationship between the feature vectors consisting of binary data, denoted as X, and the associated objective variables, denoted as Y. A quantum state of the quantum model is measured by the quantum computer by employing a quantum circuit to obtain a collection X_{S} of observed bitstrings (sequence of binary digits). In one embodiment, a quantum circuit |φ(θ) [symbol] , with N qubits is employed. In one embodiment, such a quantum circuit is parameterized by certain circuit parameters θ. In one embodiment, bitstring sampling is performed by measuring this quantum circuit as shown by the following formula:

$$\vert φ ( θ ) 〉 \approx {\sum }_{x ∈ {X}_{S}} a ( x ) \vert x 〉 .$$

Furthermore, index values Y_{S} are calculated by a classical computer based on the collection X_{S} of observed bitstrings, which are contained in X_{K} (binary data of known dataset) and X_{U} (binary data of the unknown dataset). Index values Y_{S}, as used herein, refer to the objective variables of the dataset. In one embodiment, index values, Y_{S}, correspond to the index value Y_{K} (index values based on X_{K}) and the index values Y_{U} (index values based on X_{U}). In one embodiment, index value Y_{U} are obtained from X_{U} using quantum model (F). An optimal indicator value, Ind, is calculated by the classical computer based on the index values and the collection of observed bitstrings. For example, in one embodiment, the optimal indicator value, Ind, is computed across the obtained dataset D_{S}={X_{S}, Y_{S}}. In one embodiment, with the obtained data sampling D_{S}, the optimal indicator value (z) is calculated as follows:

$$z = {min}_{x ∈ {X}_{S}} Ind ( x , y ) , y ∈ f ( {X}_{S} ⋂ {X}_{K} ) ⋃ F ( {X}_{S} ⋂ {X}_{U} ) .$$

The data point that optimizes the indicator value is then identified by the quantum computer by employing the quantum circuit after updating the parameters of the quantum circuit. For example, in one embodiment, after updating the quantum circuit parameters θ, the actual value of y*=f(x*) for x*=argmin Ind(x, y) is measured through experiment or simulation, where x*, y* correspond to the new data point and where argmin corresponds to the function that returns the value of x* which optimizes (e.g., minimizes) f(x*) over the set of candidates for x* as opposed to the minimum value itself. The dataset D_{K} (known dataset) is then updated by the classical computer with the identified data point, {x*, y*}, and the best indicator value within the updated dataset D_{K} is adjusted accordingly. For example, the best indicator value is adjusted to correspond to the value of z. In this manner, new data points may be effectively selected from a limited dataset that optimizes (minimizes or maximizes) an indicator value by combining quantum and classical elements in order to obtain or predict the optimal indicator value. Furthermore, in this manner, there is an improvement in the technical field involving data augmentation.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for augmenting a limited dataset with data to optimize an indicator value, the method comprising:
training, on a quantum computer, a quantum model with said dataset;
measuring, by said quantum computer, a quantum state of said quantum model by employing a quantum circuit to obtain a collection of observed bitstrings;
calculating, by a classical computer, index values based on said collection of observed bitstrings;
calculating, by said classical computer, said indicator value based on said index values and said collection of observed bitstrings;
identifying, by said quantum computer, a data point that optimizes said indicator value; and
updating, by said classical computer, said dataset with said identified data point.

2. The method as recited in claim 1 further comprising:
updating, by said classical computer, parameters of said quantum circuit that optimizes said indicator value.

3. The method as recited in claim 2, wherein said updating of said parameters of said quantum circuit is performed using stochastic methods, wherein said stochastic methods comprise one of the following from the group consisting of Bayesian optimization and covariance matrix adaptation evolution.

4. The method as recited in claim 2 further comprising:
identifying, by said quantum computer, said data point that optimizes said indicator value by employing said quantum circuit after updating said parameters of said quantum circuit.

5. The method as recited in claim 2 further comprising:
measuring, by said quantum computer, a value of an objective variable as a function of binary data that optimizes said indicator value by employing said quantum circuit after updating said parameters of said quantum circuit, wherein said objective variable and said binary data collectively form said identified data point.

6. The method as recited in claim 1 further comprising:
adjusting a best indicator value within said dataset with said identified data point.

7. The method as recited in claim 1, wherein said quantum model is constructed based on machine learning models.

8. A computer program product for augmenting a limited dataset with data to optimize an indicator value, the computer program product comprising one or more computer readable storage mediums having program code embodied therewith, the program code comprising programming instructions for:
training, on a quantum computer, a quantum model with said dataset;
measuring, by said quantum computer, a quantum state of said quantum model by employing a quantum circuit to obtain a collection of observed bitstrings;
calculating, by a classical computer, index values based on said collection of observed bitstrings;
calculating, by said classical computer, said indicator value based on said index values and said collection of observed bitstrings;
identifying, by said quantum computer, a data point that optimizes said indicator value; and
updating, by said classical computer, said dataset with said identified data point.

9. The computer program product as recited in claim 8, wherein the program code further comprises the programming instructions for:
updating, by said classical computer, parameters of said quantum circuit that optimizes said indicator value.

10. The computer program product as recited in claim 9, wherein said updating of said parameters of said quantum circuit is performed using stochastic methods, wherein said stochastic methods comprise one of the following from the group consisting of Bayesian optimization and covariance matrix adaptation evolution.

11. The computer program product as recited in claim 9, wherein the program code further comprises the programming instructions for:
identifying, by said quantum computer, said data point that optimizes said indicator value by employing said quantum circuit after updating said parameters of said quantum circuit.

12. The computer program product as recited in claim 9, wherein the program code further comprises the programming instructions for:
measuring, by said quantum computer, a value of an objective variable as a function of binary data that optimizes said indicator value by employing said quantum circuit after updating said parameters of said quantum circuit, wherein said objective variable and said binary data collectively form said identified data point.

13. The computer program product as recited in claim 8, wherein the program code further comprises the programming instructions for:
adjusting a best indicator value within said dataset with said identified data point.

14. The computer program product as recited in claim 8, wherein said quantum model is constructed based on machine learning models.

15. A system, comprising:
a memory for storing a computer program for augmenting a limited dataset with data to optimize an indicator value; and
a processor connected to said memory, wherein said processor is configured to execute program instructions of the computer program comprising:
training, on a quantum computer, a quantum model with said dataset;
measuring, by said quantum computer, a quantum state of said quantum model by employing a quantum circuit to obtain a collection of observed bitstrings;
calculating, by a classical computer, index values based on said collection of observed bitstrings;
calculating, by said classical computer, said indicator value based on said index values and said collection of observed bitstrings;
identifying, by said quantum computer, a data point that optimizes said indicator value; and
updating, by said classical computer, said dataset with said identified data point.

16. The system as recited in claim 15, wherein the program instructions of the computer program further comprise:
updating, by said classical computer, parameters of said quantum circuit that optimizes said indicator value.

17. The system as recited in claim 16, wherein said updating of said parameters of said quantum circuit is performed using stochastic methods, wherein said stochastic methods comprise one of the following from the group consisting of Bayesian optimization and covariance matrix adaptation evolution.

18. The system as recited in claim 16, wherein the program instructions of the computer program further comprise:
identifying, by said quantum computer, said data point that optimizes said indicator value by employing said quantum circuit after updating said parameters of said quantum circuit.

19. The system as recited in claim 16, wherein the program instructions of the computer program further comprise:
measuring, by said quantum computer, a value of an objective variable as a function of binary data that optimizes said indicator value by employing said quantum circuit after updating said parameters of said quantum circuit, wherein said objective variable and said binary data collectively form said identified data point.

20. The system as recited in claim 15, wherein the program instructions of the computer program further comprise:
adjusting a best indicator value within said dataset with said identified data point.
